(19) United States
(12) Patent Application Publication
(10) Pub. No.: US 2020/0080294 A1
(43) Pub. Date: Mar. 12, 2020

(54) MODULAR TIRE SERVICE STATION

(71) Applicant: The Goodyear Tire & Rubber Company, Akron, OH (US)

(72) Inventors: Ryan Douglas Hartschuh, Wadsworth, OH (US); Justin Marcus Beck, Akron, OH (US)

(21) Appl. No.: 16/125,817

(22) Filed: Sep. 10, 2018

(51) Int. Cl. E04B 1/348; B60S 5/00; E04B 1/343; E04H 5/06; E04H 1/12

(52) U.S. Cl. CPC E04B 1/34815; B60S 5/00; E04B 1/34336; B60C 25/00; E04H 1/1233; E04H 2001/1283; E04H 5/06

(57) ABSTRACT

A modular tire service station for servicing vehicle tires includes a first pre-configured service module and a second pre-configured service module that is proximate the first module. A customer area is disposed in at least one of the first module and the second module, a tire storage area is disposed in at least one of the first module and the second module, and a tire service area is disposed in at least one of the first module and the second module.

### FIELD OF THE INVENTION

The invention relates to the servicing and sale of vehicle tires. More particularly, the invention is directed to a service station that enables tire servicing and potential sale in pre-equipped, easily transportable modules with customizable configurations.

### BACKGROUND OF THE INVENTION

Conventional pneumatic tires are designed to perform for relatively long periods of time. Nevertheless, such tires are each formed with a ground-engaging tread that necessarily wears down over the life of the tire. When the tread wears down to a certain level, replacement of the tire is recommended.

In addition, pneumatic tires are subject to air pressure losses due to puncture by nails and other sharp objects, temperature changes, and/or diffusion of air through the tire itself. Such air pressure losses may lead to a need to repair or replace the tire.

Traditionally, tire repair and replacement, known as tire servicing, has been performed at a commercial garage, service center or other permanent brick-and-mortar establishment. Tire servicing at this type of permanent establishment has been necessary due to the heavy-duty equipment that is needed to jack up the vehicle to remove the tire and the wheel or rim on which the tire is mounted, to extract the tire from the wheel, install a new or repaired tire on the wheel, balance the new or repaired tire and wheel, inflate the new or repaired tire, and install the new or repaired tire and wheel on the vehicle. In addition, a significant amount of storage space has been needed to maintain an inventory of tires of different types and sizes.

A disadvantage of permanent establishments is the significant time and expense associated with purchasing or leasing land and then building a permanent building on the land. Because of such time and expense, there are many geographic areas where commercial garages or service centers are not present, which is an inconvenience to users needing tire servicing.

In an attempt to address this issue, prior art service trucks were developed. These trucks were heavy-duty vehicles that included some equipment used for tire servicing and which were capable of traveling to different locations. However, being vehicles, such trucks could not always remain in a specific location for an extended period of time and had limited space for equipment and tire storage. In addition, as vehicles, such trucks often had high operating costs due to fuel consumption and maintenance.

As a result, there is a need in the art for a station that enables tire servicing and optional tire sales with an easy-to-maintain, re-locatable structure which requires minimal infrastructure investment.

### SUMMARY OF THE INVENTION

According to an aspect of an exemplary embodiment of the invention, a modular tire service station for servicing vehicle tires includes a first pre-configured service module and a second pre-configured service module that is proximate the first module. A customer area is disposed in at least one of the first module and the second module, a tire storage area is disposed in at least one of the first module and the second module, and a tire service area is disposed in at least one of the first module and the second module.

### BRIEF DESCRIPTION OF THE DRAWINGS

The invention will be described by way of example and with reference to the accompanying drawings, in which:

FIG. 1 is a schematic perspective view of an exemplary embodiment of a modular tire service station of the present invention;

FIG. 2 is a schematic plan view of the modular service station shown in FIG. 1, with vehicles in the service station area;

FIG. 3 is a schematic plan view of an example of a configuration of a first module of the modular service station shown in FIG. 1;

FIG. 4 is a schematic plan view of an example of a configuration of a second module of the modular service station shown in FIG. 1;

FIG. 5 is a schematic plan view of an alternative configuration of the first module of the modular service station shown in FIG. 1; and

FIG. 6 is a schematic plan view of an alternative configuration of the second module of the modular service station shown in FIG. 1.

Similar numerals refer to similar parts throughout the drawings.

### DETAILED DESCRIPTION OF THE INVENTION

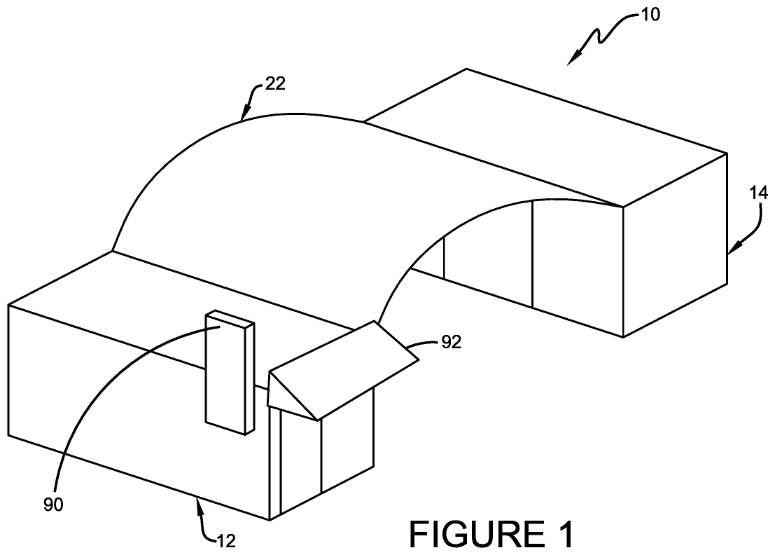

Turning to FIG. 1, an exemplary embodiment of modular tire service station of the present invention is indicated generally at 10. The modular service station 10 enables automobile tire servicing for customers with minimal infrastructure investment, and may function as a point of sale and an installation location, as will be described below.

The modular service station 10 includes at least two pre-built and pre-configured service modules 12 and 14 that contain all equipment needed for tire servicing. For example, the modules 12 and 14 preferably are pre-fabricated rigid containers, such as shipping containers. When shipping containers are used, each module 12 and 14 may be about eight feet wide by about twenty feet long. Of course, other dimensions for each module 12 and 14 may be employed based upon particular design considerations, such as about ten feet wide by about seventeen feet long. Such dimensions enable each module 12 and 14 to be configured with all equipment at a central location, and then transported by a heavy-duty vehicle, such as a semi-truck with a flat-bed, tilt-bed or other trailer, to a service site. In addition, when the modular service station 10 is desired to be re-located it can be picked up and transported by a heavy-duty vehicle to a new location.

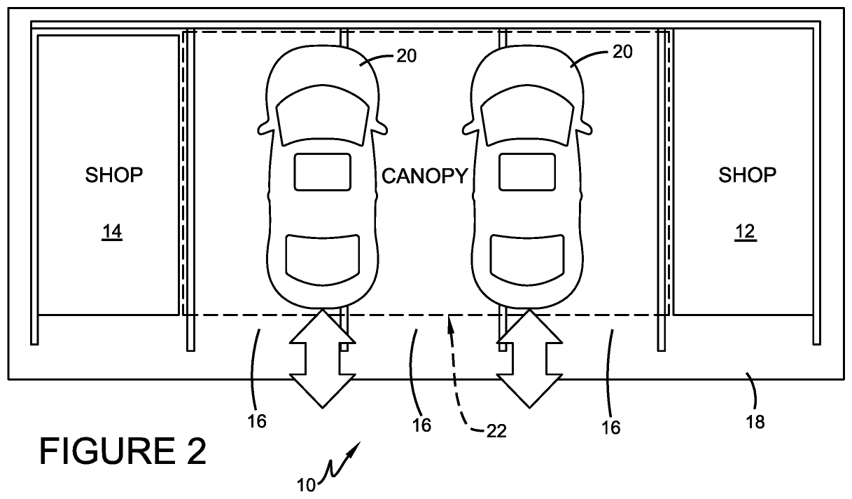

With additional reference to FIG. 2, the modular service station 10 is configured to fit within a limited number of parking spaces 16 in a parking lot 18, such as about five to ten parking spaces. Such a configuration enables the modular service station 10 to be disposed in a large parking lot 18 as the service site for convenience, as will be described in greater detail below. Preferably, the two modules 12 and 14 are proximate one another, and may be spaced apart in a parallel manner with two or more parking spaces 16 between them, which enables one or more vehicles 20 to park between the modules for servicing.

Preferably, the modular service station 10 includes an awning or canopy 22 that is attached to and extends between the modules 12 and 14 over the parking spaces 16 to shelter the vehicles 20 from sun, rain and snow. The size of the canopy 22 depends on the number of parking spaces 16 to be available between the modules 12 and 14. For example, when about two parking spaces 16 are available, the canopy 22 is from about fourteen feet wide by about eighteen to about twenty feet long. When about three or four parking spaces 16 are available between the modules 12 and 14, the canopy is from about twenty-seven feet wide by about eighteen to about twenty feet long. In this manner, the canopy 22 is formed with approximately the same length as each module 12 and 14 and a width as desired based upon the parking spaces 16 to be used for servicing the vehicles 20.

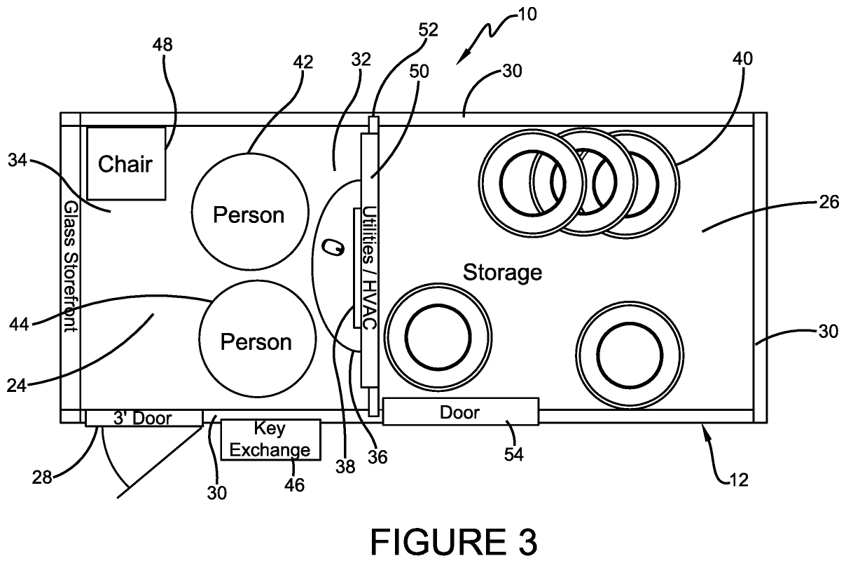

Each module 12 and 14 includes a rectangular configuration of external walls 30 and may be configured according to specific design considerations. For example, referring now to FIG. 3, a first module 12 may include a customer area 24 and a tire storage area 26. Preferably, a door 28 is included in one of the external walls 30 of the module 12 to enable customers 42 to enter the customer area 24. The customer area 24 preferably further includes a customer interface area 32 and a customer waiting area 34.

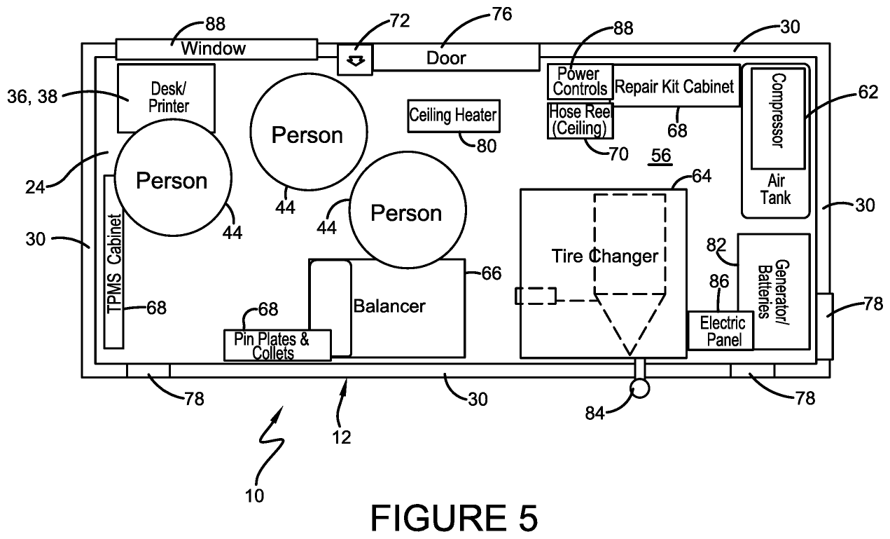

The customer interface area 32 serves as a point of information or sale for the customer 42. The customer interface area 32 may be a minimal area, as shown in FIG. 5 and described below, or a relatively large area as shown in FIG. 3 and described now. More particularly, the customer interface area is equipped with a desk or a cabinet and counter 36 to support a computer, monitor and printer configuration 38. Preferably, the computer 38 is connected to a wireless network to enable customers 42 to check in or out of the modular service station 10, as well as to confirm and/or place orders. For example, a customer 42 may order new tires 40 in advance through an online or phone system and schedule a service appointment to occur at the modular service station 10 through the online or phone system. When the customer arrives 42 at the modular service station 10 for tire servicing, the customer may confirm the order and check in using the computer 38, with or without the assistance of a technician 44. Alternatively, the customer 42 may visit the modular service station 10 to order new tires 40 and schedule a service appointment using the computer 38 with or without the assistance of the technician 44.

The customer area 24 optionally includes a key exchange box 46, which enables the customer 42 to leave his or her car keys at the modular service station 10 for use by the technician 44 as needed for tire servicing. The key exchange box 46 also enables the customer 42 to pick up his or her keys upon returning to the modular service station 10 if the technician 44 is unavailable.

As mentioned above, the customer area 24 preferably includes a customer waiting area 34. The modular service station 10 is configured to be located in a parking lot 18, such as the parking lot of a shopping center, which enables the customer 42 to walk to the nearby stores and shop and/or run errands during tire servicing. However, if the customer 42 elects to remain at the modular service station 10 during tire servicing, the customer waiting area 34 optionally includes furniture, such as a chair 48. In order to provide comfort for the customer 42, the customer area 24 preferably also includes a conditioned environment, such as a heating, ventilation and air conditioning (HVAC) unit 50 and easy-to-clean flooring.

The customer area 24 is preferably separated from the storage area 26 by an internal wall 52, which enables the new tires 40 to be stored in the storage area without intruding upon the relative comfort of the customer area. A wide door 54 is included in one of the external walls 30 of the module 12 to enable new tires 40 to be moved in and out of the storage area 26. Because the new tires 40 preferably are ordered in advance and delivered to the modular service station 10, the storage area 26 only needs to include enough space to store a few dozen tires for upcoming service appointments, rather than hundreds or thousands of tires. For example, the storage area may be about eight feet by about ten feet, which is about eighty square feet total, as opposed to the hundreds or thousands of square feet required in the prior art. The storage area 26 includes a durable floor and may optionally be outfitted with racks to store tires 40.

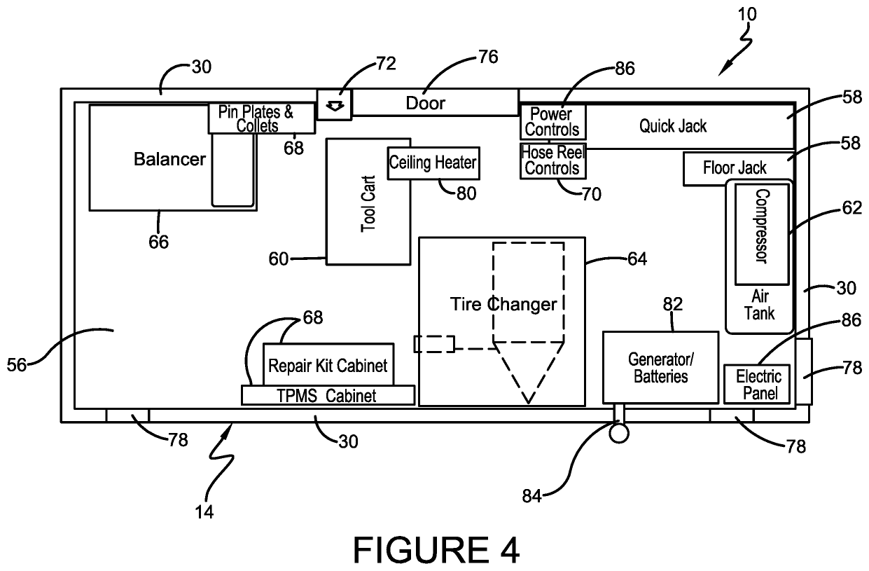

Turning now to FIG. 4, a second module 14 preferably includes a tire service area 56. The service area 56 includes equipment needed to perform tire servicing. For example, the equipment preferably includes one or more jacks 58 to jack up the vehicle 20 (FIG. 2) in order to remove the old tire and the wheel on which the old tire is mounted. A tool cart 60 is provided to store hand-held tools such as an impact wrench for the removal of the wheel from the wheel studs, as known to those skilled in the art. An air compressor and air tank unit 62 supplies compressed air to any hand-held tools that are pneumatically powered. Once the old tire and rim are removed from the vehicle 20, a tire changer 64 is used to extract the old tire from the wheel and to install the new tire 40 (FIG. 3) onto the wheel. The air compressor and air tank unit 62 supplies compressed air for inflation of the new tire 40. The new tire 40 is balanced on the wheel using a balancer 66 before being installed on the vehicle 20.

One or more cabinets 68 are provided to store parts for balancing, replacement of parts for a tire pressure monitoring system (TPMS), and/or other parts that may be needed for tire replacement or repair. A hose reel 70 is included to enable easy use and storage of pneumatic air lines that extend between the air compressor and tank unit 62, the tire changer 64 and any pneumatic hand-held tools. For safety, at least one fire extinguisher 72 is mounted to one of the external walls 30 of the second module 14. A wide door 76 is included in one of the external walls 30 of the module 14 to enable the technician 44 (FIG. 3) to bring the jacks 58, old tires, new tires 40, wheels and other items in and out of the service area 56 as needed. The second module 14 includes one or more exhaust vents or louvres 78 formed in one or more of the external walls 30 for ventilation, and an optional heater 80 to provide a conditioned environment and thus comfort for the technician 44. The second module 14 may also include lighting, such as ceiling-mounted LED lights, and insulation to reduce the sound heard outside of the service area 56 generated by the above-described equipment.

Preferably, the air compressor and tank 62, the tire changer 64 and the balancer 66 are mounted to or otherwise secured to the walls 30 and/or the floor of the second module 14. Other equipment, such as the jacks 58 and the tool cart 60, may be on casters for portability between the service area 56 and the vehicle 20 in the parking spaces 16.

The second module 14 preferably also includes the power system for the modular service station 10. More particularly, the modular service station 10 is a self-contained unit, and includes its own power generating means. Preferably, the power generating means are located in the second module 14 with the service area 56, and any power that is needed by the first module 12 is provided through electrical lines extending between the first and second modules.

The power generating means preferably includes a generator and battery unit 82. The generator and battery unit 82 includes a generator that generates electricity and batteries that store the generated electricity for use by any of the above-described electrical devices or equipment in the first and second modules 12 and 14. Solar panels may be employed in place of, or in combination with, the generator and battery unit 82. Of course, other combinations for the power generating means may be employed, such as a generator without a battery and solar panels with a battery, based on particular design considerations. An exhaust vent 84 is formed in one of the external walls 30 of the second module 14 to enable the generator and battery unit 82 to vent exhaust as needed. An electrical panel 86 is attached to one of the external walls 30 of the second module 14 to divide the power feed from the generator and battery unit 82 into circuits with circuit breakers for the connection of the above-described electrical devices or equipment. A control panel 88 that is electrically connected to the electrical panel 86 may be provided to enable central control of the above-described electrical devices or equipment.

The power generating means for the modular service station 10 preferably includes a 120-volt system capable of producing about 70 amps to about 80 amps, or about 8,400 watts to about 9,600 watts. The following table provides an example of particular power requirements of the modular service station 10.

| Equipment | Maximum Amps | Volts | Watts |
|---|---|---|---|
| Compressor (2HP, 15 gal) | 14 | 120 | 1680 |
| Tire changer (9824 | 6.3 | 120 | 750 |
| Balancer (9250 | 0.8 | 120 | 100 |
| Radiant heater 1 (Fostoria) | 7.5 | 120 | 900 |
| Exhaust fan(s) | 2 | 120 | 240 |
| Lights (LED) | 3 | 120 | 360 |
| Lift | 15 | 120 | 1800 |
| Customer HVAC (tbd) | 14 | 120 | 1680 |
| Radiant heater 2 (Fostoria | 7.5 | 120 | 900 |
| Two 20 amp circuits | n/a | 120 | 0 |
| (miscellaneous receptacle needs) | | | |
| Total | 70.1 | | 8410 |

Of course, the power requirements for the power generating means, such as the generator and battery unit 82, may vary based upon particular configurations of the equipment employed in the modular service station 10.

In this manner, the modular service station 10 enables a customer 42 to order new tires 40 and schedule an appointment for tire servicing. The new tires 40 are delivered to the tire storage area 26. The customer 42 parks his or her vehicle 20 in one of the parking spaces 16 under the canopy 22, checks in at the customer area 24, and may walk to a nearby store or wait at the customer area for the tire servicing to be performed. The new tires 40 are moved from the storage area 26 to the service area 56. Equipment such as a jack 58 is brought out to the vehicle 20 to remove the old tires and wheels. The old tires and wheels are brought into the service area 56, where each old tire is removed from its respective wheel and the new tire 40 is installed on the wheel and balanced, using equipment such as the tire changer 64 and the balancer 66. The new tires 40 on the wheels are brought out and installed on the vehicle 20 under the canopy 22, and the vehicle is ready for customer pickup.

In the modular service station 10, there may be other specific combinations or arrangements of the customer area 24, the storage area 26 and the service area 56 in the each of the first and second modules 12 and 14 than the above-described arrangement.

For example, the first module 12 may include an alternative arrangement as shown in FIG. 5. In this arrangement, the first module 12 may include the customer area 24 and the service area 26. More particularly, the customer area 24 may include a window 88 formed in one of the external walls 30, as well as the desk 36 with the computer 38. The customer 42 (FIG. 3) speaks to one of the technicians 44 through the window 88, and the technician uses the computer 38 for customer check-in and processing. The service area 26 includes the rigidly-mounted service equipment, such as the air compressor and tank 62, the tire changer 64 and the balancer 66, as well as the cabinets 68 and the hose reel 70. The service area 26 also includes the service roll-up door 76, fire extinguisher 72, exhaust vents or louvres 78, heater 80, as well as the power system, including the generator and battery unit 82, the exhaust vent 84, the electrical panel 86 and the control panel 88.

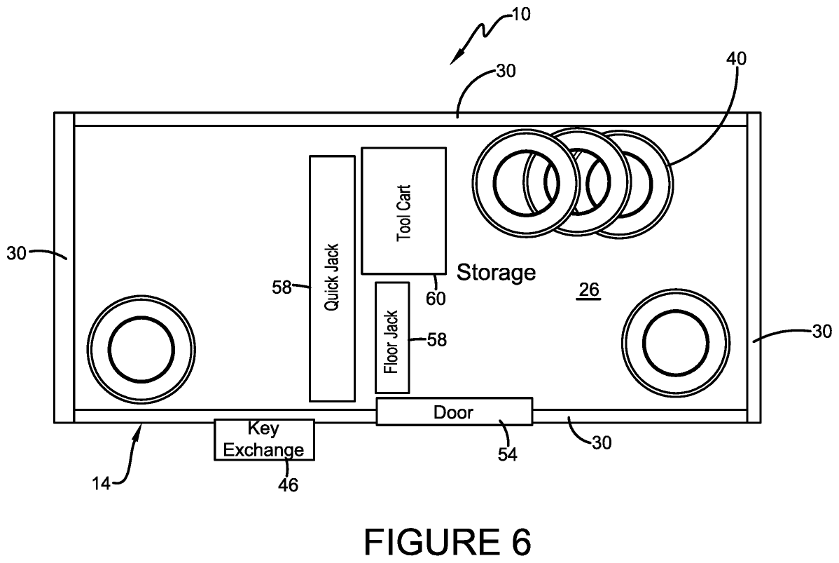

Also in this arrangement, as shown in FIG. 6, the second module 14 may include the storage area 26 and portable equipment. More particularly, the new tires 40 are stored in the storage area 26 in the second module 14, and the storage roll-up door 54 is included in one of the external walls 30 to enable the tires to be moved in and out of the second module. The portable servicing equipment, such as the jacks 58 and the tool cart 60, are stored in the storage area 26 when they are not in use in the parking spaces 16 (FIG. 2). The key exchange box 46 may also be attached to one of the walls 30 of the second module 14.

The appearance of the modular service station 10 is flexible, as the exterior design of the modules 12 and 14, as well as the canopy 22, may be adapted to match surrounding buildings. For example, the exterior of the modules 12 and 14 may be painted to match buildings adjacent the parking lot 18 and/or may be covered with a fascia, such as brick fascia to match brick buildings. Exterior signs 90 and awnings 92 (FIG. 1) may optionally be attached to one or both of the modules 12 and 14, based upon particular design considerations.

The modular service station 10 is quiet and clean to operate, as the generator 82, compressor 62 and other equipment preferably are reduced-noise models. In addition, such equipment may be located within a module 12 or 14 with sound-insulated walls 30. Moreover, certain tools, such as hand-operated tools, may be battery operated to reduce the noise generated in the tire servicing operation. The modular and compact configuration of the service station 10 enables easy cleaning of the modules 12 and 14 and the parking spaces 16.

Because of the modular configuration of the modular service station 10, the service station can be sized or scaled appropriately for the expected volume of business. For example, in a busy area, one module 12 may be used for the customer area 24 and the storage area 26, while multiple modules 14 may be used for multiple service areas 56 Likewise, multiple modules 12 or 14 may be used for multiple storage areas 26. In addition, a larger canopy 22 may be used to enable more parking spaces 16 to be employed, for servicing of a larger number of vehicles 20. Thus, three or more modules 12 and 14 may be employed without affecting the overall concept or operation of the invention. In addition, while the modules 12 and 14 have been described above as preferably being spaced apart in parallel fashion, they may be arranged in alternative configurations, such as an L-shaped configuration, to suit particular design and space considerations without affecting the overall concept or operation of the invention.

In this manner, the modular service station 10 enables tire servicing and sales in pre-equipped, easily transportable modules 12 and 14, which can be located in an existing parking lot 18. The modular service station 10 thus provides a station that enables tire servicing with a customizable and easy-to-maintain structure which requires minimal infrastructure investment.

The present invention also includes a method of servicing tires using a modular service station 10. The method includes steps in accordance with the description that is presented above and shown in FIGS. 1 through 6.

It is to be understood that the structure of the above-described modular tire service station may be altered or rearranged, or components or steps known to those skilled in the art omitted or added, without affecting the overall concept or operation of the invention. For example, the number and/or spacing arrangement of the modules 12 and 14 may be changed according to specific design considerations, or the configuration of the customer area 24, the storage area 26 and the service area 56 in the modules may be adjusted, without affecting the overall concept or operation of the invention.

The invention has been described with reference to preferred embodiments. Potential modifications and alterations may occur to others upon a reading and understanding of this description. It is to be understood that all such modifications and alterations are included in the scope of the invention as set forth in the appended claims, or the equivalents thereof.

1. A modular service station for servicing vehicle tires, comprising:
a first pre-configured transportable service module;
a second pre-configured transportable service module proximate the first module and being spaced apart from the first module;
a customer area disposed in the first transportable module;
a tire storage area disposed in at least one of the first transportable module and the second transportable module;
a tire service area disposed in at least one of the first transportable module and the second transportable module; and
a vehicle parking area disposed in the space between the first transportable module and the second transportable module, the vehicle parking area for receiving a vehicle to be serviced.

2. The modular service station of claim 1, wherein the first module is spaced apart from the second module in a parallel manner, and a canopy is attached to and extends between the first module and the second module.

3. The modular service station of claim 2, wherein the first module and the second module are disposed in a parking lot with at least two parking spaces between them.

4. The modular service station of claim 1, wherein the modules are pre-fabricated transportable containers.

5. The modular service station of claim 1, wherein the customer area includes a door formed in a wall of the at least one of the first module and the second module to enable customers to enter the customer area.

6. The modular service station of claim 1, wherein the customer area further comprises a customer interface area that includes a computer, monitor and printer configuration.

7. The modular service station of claim 1, wherein the customer area further comprises a customer waiting area.

8. The modular service station of claim 1, wherein at least one of the first module and the second module includes a key exchange box.

9. The modular service station of claim 1, wherein the customer area and the tire storage area are disposed in the first module, and the customer area is separated from the tire storage area by an internal wall.

10. The modular service station of claim 1, wherein the tire service area includes at least one of a tool cart, an air compressor and air tank unit, a tire changer and a balancer.

11. The modular service station of claim 10, wherein the tire service area is disposed in the second module, and the second module includes a wall in which at least one exhaust vent is formed.

12. The modular service station of claim 11, wherein at least one of the air compressor and air tank unit, the tire changer and the balancer are mounted to at least one of a wall and a floor of the second module.

13. The modular service station of claim 12, wherein walls of the second module include sound-reducing insulation.

14. The modular service station of claim 1, wherein at least one of the first module and the second module includes power generating means.

15. The modular service station of claim 14, wherein the power generating means includes a generator and battery unit.

16. The modular service station of claim 14, wherein the power generating means includes a 120-volt system capable of producing about 70 amps to about 80 amps.

17. The modular service station of claim 1, wherein the customer area and the tire service area are disposed in the first module.

18. The modular service station of claim 1, wherein the tire storage area is disposed in the second module.

19. The modular service station of claim 1, wherein the first module and the second module are disposed in an L-shaped pattern relative to one another.

20. The modular service station of claim 1, wherein at least one of the customer area, the tire storage area and the tire service area includes a conditioned environment.
